(19) United States
(12) Patent Application Publication
(10) Pub. No.: US 2005/0081892 A1
(43) Pub. Date: Apr. 21, 2005

(54) Cleaning composition containing EDTA for cleaning formers

(76) Inventors: Apala Mukherjee, South Orange, NJ (US); Nongnuch Chiraphaphisarn, Samutprakarn (TH); Pak Lian Leong, Kuala Lumpur (MY); Chaodong Xiao, East Hanover, NJ (US)

Correspondence Address: NATIONAL STARCH AND CHEMICAL COMPANY, P.O. BOX 6500, BRIDGEWATER, NJ, 08807-3300, US

(21) Appl. No.: 10/690,364

(22) Filed: Oct. 21, 2003

(51) Int. Cl. B08B 3/04

(52) U.S. Cl. 134/22.1; 134/26; 134/42

(57) ABSTRACT

The invention relates to a cleaning composition effective for the removal of coagulant residue from molds or formers used for forming latex articles. The cleaning composition is an aqueous solution containing ethylene diaminetetraacetate (EDTA) ions. The composition can be used alone, or as part of a system with one or more water baths and one or more ETDA, detergent or base containing baths, for the cleaning of formers or molds.

### FIELD OF THE INVENTION

The invention relates to a cleaning composition effective for the removal of coagulant residue from molds or formers used for forming latex articles. The cleaning composition is an aqueous solution containing ethylene diaminetetraacetate (EDTA) ions. The composition can be used alone, or in series with one or more water baths and one or more ETDA, detergent or base containing baths, for the cleaning of formers or molds.

### BACKGROUND OF THE INVENTION

Latex articles, such as gloves, are formed by dipping a mold or former into a coagulant, then into a rubber latex. The latex is cured on the former, then removed to produce a formed-latex article. In order to facilitate the removal of the latex article form the mold or former, a release agent is generally used. The release agent has traditionally been a particulate, such as starch or calcium carbonate. More recently polymeric release coatings have been used.

Once the latex article, has been removed from the former, there remains a residue containing calcium from the coagulant, plus a polymeric or non-polymeric release agent. Over many cycles, the mold or former may begin to accumulate small amounts of the tacky rubber latex, as well as coagulant and release agent. The film can turn the former brown due to iron chelation. For continuous operation of the production line, it is important to remove coagulant contamination, leaving clean molds or formers.

The current method of removing the film is by immersing the former into hot acid (such as hydrochloric or nitric acids, above 55° C.) at a concentration of at least 2 percent, followed by immersion in a water bath, a base such as 1 percent potassium hydroxide, and a final water bath. If the acid in not hot, the ion exchange is inefficient.

The cleaning of the formers is especially a problem on textured formers. While smooth formers may be cleaned by dipping in the cleaning solutions, the cleaning of a textured former requires brushing.

In U.S. Pat. No. 5,647,988, a ceramic membrane separation apparatus can be used for water purification and wastewater treatment. When this apparatus become clogged with organic matter, it can be cleaned by back-washing with aqueous oxidizing agent (such as sodium hypochlorite) acid, base, or a combination thereof.

U.S. Pat. Nos. 5,895,781 and 5,910,475 describe cleaning compositions for ceramic and porcelain surfaces, such as sinks and toilets, which have stained due to mineral deposits. The mineral deposits are caused by metal complexes formed from high oxidation state metal ions. The cleaning composition contains sulfamic acid, isoascorbic acid (as a reducing agent), a surfactant system, and a complexing system of ethylenediaminetetraacetic acid and citric acid.

There is a need for an alternative method for cleaning formers, especially a method that does not involve hot acid. Surprisingly it has been found that the use of a cleaning system containing EDTA ions results in the removal of residual film build-up on formers or molds. The cleaning system is effective with or without abrasion, and with or without heat.

### SUMMARY OF THE INVENTION

It is an object of the invention to obtain a method of removing residual coagulant from a former without the use of brushing.

Another object of the invention is to obtain a minimal amount of residue with a short dip time in a cleaning solution.

Still another object of the invention is to obtain the cleaning of the former without the need for heat.

The invention is directed to a cleaning system for the removal of coagulant residue from molds and formers comprising:
a) a first bath (a) comprising an aqueous solution comprising, wherein said EDTA are present at from 0.1 to 30 percent by weight; and
b) a second bath (c) comprising an aqueous solution of from 0.5 to 15 weight percent of one or more cleaning agents selected from the group consisting of ETDA, detergent, and base.

The invention is further directed to a method for cleaning a mold or former for forming a latex article, wherein said method comprises:
a) immersing a mold or former into a bath comprising EDTA;
b) optionally immersing said mold or former into at least one water bath;
c) optionally immersing said mold or former into a second cleaning bath comprising an aqueous solution of from 0.5 to 2 weight percent of one or more cleaning agents selected from the group consisting of ETDA, detergent, and base; and
d) optionally immersing said mold or former into a final water bath.

### DETAILED DESCRIPTION OF THE INVENTION

The present invention relates to a method for cleaning coagulant residue from molds used in forming latex articles.

As used herein, the term ETDA refers to ethylene diaminetetraacetate which will dissociate into ions in an aqueous solution. The EDTA can be combined with any counter ion, a preferred counter ion being sodium.

In the process of forming a latex article, a mold or former is dipped into a coagulant solution, then dipped into a latex rubber. The mold or former is generally made of ceramic or porcelain, and may be smooth or textured. The coagulant causes the latex rubber to coagulate and form a film on the mold or former. The latex rubber article is then cured and removed from the former. Some coagulant containing calcium and polymeric or non-polymeric residue remains on the former.

The cleaning system of the present invention is useful for removing the coagulant residue from the mold or former. The cleaning system in its simplest form consists of a single bath having an aqueous cleaning composition containing ETDA ions. The concentration of the EDTA ions is between 0.1 and 30 weight percent, based on the whole aqueous composition. Preferably the EDTA ions are present at from 0.5 to 15 weight percent, and more preferably at from 1 to 10 weight percent.

An EDTA-containing compound is added to water to form the EDTA ion solution. Preferably the EDTA compound is an alkali metal or ammonium salt. Especially preferred salts are sodium EDTA and ammonium EDTA, or a mixture thereof.

In addition to the EDTA ions and water, the first bath may further contain other components that aid in the cleaning of the former or mold. These components include detergents and bases.

It has been found to be advantageous to include a detergent in the first cleaning composition. Detergents, as used herein includes compounds known in the art as detergents or surfactants. Detergents useful in the cleaning composition include non-ionic, anionic, cationic and amphoteric surfactants. Examples of useful surfactants include, but are not limited to, sodium salts of alkyl benzene sulfonate, lauryl ether sulfate, diethylene glycol monobutyl ether, nonyl phenol ethoxylate. The level of detergent, if present, will be about half the weight of the EDTA, or between 0.005 percent and 15 percent by weight based on detergent solids to the total bath composition. Preferred levels of the detergent are from 0.25 to 7.5 percent, and more preferably from 0.5 to 5 percent.

A base may optionally be present in the first bath at a level of from 0.01 to 10 percent by weight, preferably from 0.5 to 2 percent by weight. The base may be any inorganic or organic base, or a mixture thereof. Preferred bases include potassium hydroxide, sodium hydroxide, ammonium hydroxide, or a mixture thereof.

Preferably the cleaning system includes a second bath containing EDTA, a base, a detergent, or a combination thereof. In a preferred embodiment, the second bath is either an EDTA/detergent mixture, or a base. One particular embodiment useful in the invention would be 2 to 6 percent of EDTA and 1 to 3 percent of a detergent. The total concentration of EDTA, detergent, and base in the second bath is from 0.5 to 15 weight percent.

It has been found that cleaning efficiency is improved when one or more water baths are used between the first and second cleaning baths, in the case when a second cleaning bath is used.

Following the final cleaning bath, it is Useful and preferred to have a final water bath, prior to placing the former or mold back into the manufacturing cycle for forming a latex article. An alternative would be to use a wet towel wipe. The water rinse, or towel wipe, help to reduce contamination from any residual chemicals. This allows for a continuous use of the line without defects in the gloves.

It is desirable to keep the water in all of the baths as clean as possible to achieve maximum film removal. It has been found that warmer water is more effective at film removal. Water at 60° C. produced slightly better cleaning, though cold water was almost as good. It was also found that most of the residue comes off of the formers in the water, rather than in the reagent baths.

The cleaning system of the present invention is for use in latex article manufacturing lines that are free of stearates. Stearates are sometimes used as part of the coagulant system. In a stearate system, EDTA ions will react with very low levels of stearate to cause gelation.

Lower temperature cleaning is possible with an EDTA/detergent concentration gradient. If both cleaning baths contain an EDTA/detergent combination, then the first cleaning tank can have a higher concentration followed by a second cleaning tank with a lower total concentration. This arrangement allows for easier removal of the residues from the formers. Similarly, EDTA/KOH also works as a concentration gradient where the first bath has a higher concentration followed by a lower concentration of EDTA/KOH cleaning agent in the second bath.

The cleaning agents work best at temperatures between 30° C. and 80° C., and preferably between 40° C. and 60° C. While heat is not required in the cleaning system, better cleaning results are found in systems at slightly elevated temperature. The dwell time in each bath is generally between 3 and 60 seconds, and preferably between 5 and 20 seconds.

The cleaning system of the present invention is effective for cleaning both smooth and textured formers without the use of brushing or other abrasive. Brushing may be used to augment the cleaning process, but is not required.

The method for cleaning a mold or former using the system of the present invention would involve the following steps:
a) The mold or former is immersed into a bath containing 0.1 to 30 weight percent of EDTA ions. The bath may optionally contain detergent and/or base.
b) Optionally, but preferably, the mold or former is then immersed in one or more water baths.
c) Optionally, but preferably, the mold or former is then immersed in a second cleaning bath containing EDTA, detergent, base, or a combination of these.
d) Optionally, but preferably the former is then immersed in a final water bath, prior to restarting the manufacturing cycle for the forming of latex articles.

The following examples are presented to further illustrate and explain the present invention and should not be taken as limiting in any regard.

### EXAMPLE 1

A porcelain former is dipped into a 20 percent solution of calcium nitrate, which serves as the latex coagulant. After 1 minutes at 120° C. oven, the former having coagulant thereon is dipped into natural rubber latex for 1 minute. The latex deposit is dried at 110° C. for 2 minutes and beaded. The beaded deposit is dipped into the water-based formulation for 20 seconds. After dipping, the former is placed in an oven and cured at 120° C. for 20 minutes. The cured deposit is allowed to cool and then stripped from the mold. The contaminated dipping mould is then cleaned with the cleaning solution as following:
Tank #1: EDTA (4 percent) and detergent (2 percent) for 10 seconds at 50° C.
Tank #2: Water for 10 seconds at 50° C.
Tank #3: EDTA (4 percent) and detergent (2 percent) for 10 seconds at 50° C.
Tank #4: Water for 10 seconds at 50° C.
There was no film left on the surface of the former

### EXAMPLE 2

After the glove is stripped from the former, the contaminated dipping mold is then cleaned with the cleaning solution as following:
Tank #1: EDTA (4 percent) and detergent (2 percent) for 10 seconds at 30° C.
Tank #2: Water for 10 seconds at 30° C.
Tank #3: EDTA (2 percent) and detergent (1 percent) for 10 seconds at 30° C.
Tank #4: Water for 10 seconds at 30° C.
There was no film left on the ceramic formers.

### EXAMPLE 3

After glove is stripped from the former, the contaminated dipping mold is then cleaned with the cleaning solution as following:
Tank #1: EDTA (2 percent) and KOH (1 percent) for 10 seconds at 50° C.
Tank #2: Water for 10 seconds at 50° C.
Tank #3: EDTA (0.5 percent) and KOH (0.5 percent) for 10 seconds at 50° C.
Tank #4: Water for 10 seconds at 50° C.
There was no film left on the ceramic formers.

### EXAMPLE 4

After glove is stripped from the former, the contaminated dipping mold is then cleaned with the cleaning solution as following:
Tank #1: EDTA (2 percent) for 10 seconds at 50° C.
Tank #2: Water for 10 seconds at 50° C.
Tank #3: KOH (0.8 percent) for 10 seconds at 50° C.
Tank #4: Water for 10 seconds at 50° C.
There was a very thin film left on the ceramic formers.

### EXAMPLE 5 (COMPARATIVE)

After glove is stripped from the former, the contaminated dipping mold is then cleaned with the cleaning solution as following:
Tank #1: Nitric (2 percent) for 10 seconds at 60° C.
Tank #2: Water for 10 seconds at 50° C.
Tank #3: KOH (0.8 percent) for 10 seconds at 50° C.
Tank #4: Water for 10 seconds at 50° C.
There was some film left on the ceramic formers.

### EXAMPLE 6 (COMPARATIVE)

After glove is stripped from the former, the contaminated dipping mold is then cleaned with the cleaning solution as following:
Tank #1: Nitric acid (2 percent) for 10 seconds at 30° C.
Tank #2: Water for 10 seconds at 30° C.
Tank #3: KOH (0.8 percent) for 10 seconds at 30° C.
Tank #4: Water for 10 seconds at 30° C.
There was lot of film left on the ceramic formers.

### EXAMPLE 7 (COMPARATIVE)

After glove is stripped from the former, the contaminated dipping mold is then cleaned with the cleaning solution as following:
Tank #1: Citric acid (2 percent) for 10 seconds at 60° C.
Tank #2: Water for 10 seconds at 50° C.
Tank #3: KOH (0.8 percent) for 10 seconds at 50° C.
Tank #4: Water for 10 seconds at 50° C.
There was lot of film left on the ceramic formers.

### EXAMPLE 8

After glove is stripped from the former, the contaminated dipping mould is then cleaned with the cleaning solution as following:
Tank #1: ALCO AL-175, a 50 percent solution of poly Acrylic Acid, sodium salt, from ALCO Chemical (2 percent) and detergent (1 percent) for 10 seconds at 60° C.
Tank #2: Water for 10 seconds at 50° C.
Tank #3: KOH (0.8 percent) for 10 seconds at 50° C.
Tank #4: Water for 10 seconds at 50° C.
There was very little film left on the ceramic formers.

### EXAMPLE 9

After glove is stripped from the former, the contaminated dipping mould is then cleaned with the cleaning solution as following:
Tank #1: ALCO AR-545, a 50 percent solution of poly Acrylic Acid-co-maleic acid, sodium salt, from ALCO Chemical Company (4 percent) for 10 seconds at 60° C.
Tank #2: Water for 10 seconds at 50° C.
Tank #3: Detergent (2 percent) for 10 seconds at 50° C.
Tank #4: Water for 10 seconds at 50° C.
There was very little film left on the ceramic formers.

### EXAMPLE 10 (COMPARATIVE)

After glove is stripped from the former, the contaminated dipping mold is then cleaned with the cleaning solution as following:
Tank #1: Acetone (2 percent) for 10 seconds at 30° C.
Tank #2: Water for 10 seconds at 50° C.
Tank #3: Acetone (2 percent) for 10 seconds at 30° C.
Tank #4: Water for 10 seconds at 50° C.
There was lot of film left on the ceramic formers.

### EXAMPLE 11 (COMPARATIVE)

After glove is stripped from the former, the contaminated dipping mould is then cleaned with the cleaning solution as following:
Tank #1: Limonene-D (2 percent) for 10 seconds at 30° C.
Tank #2: Water for 10 seconds at 50° C.
Tank #3: Limonene-D (2 percent) for 10 seconds at 30° C. 0C
Tank #4: Water for 10 seconds at 30° C.
There was lot of film left on the ceramic formers.

### EXAMPLE 12 (COMPARATIVE)

After glove is stripped from the former, the contaminated dipping mould is then cleaned with the cleaning solution as following:
Tank #1: Limonene-D (2 percent) for 10 seconds at 30° C.
Tank #2: Water for 10 seconds at 50° C.
Tank #3: Benzoflex (1 percent) for 10 seconds at 30° C.
Tank #4: Water for 10 seconds at 30° C.
There was lot of film left on the ceramic formers.

1. A cleaning system for the removal of coagulant residue from formers comprising:
a) a first bath (a) comprising an aqueous solution comprising EDTA, wherein said EDTA is present at from 0.1 to 30 percent by weight; and
b) a second bath (c) comprising an aqueous solution of from 0.5 to 15 weight percent of one or more cleaning agents selected from the group consisting of ETDA, detergent, and base.

2. The cleaning system of claim 1 wherein said first bath further comprises from 0.25 to 7.5 percent by weight of at least one detergent, 0.01 to 10 percent by weight of at least one base, or a combination thereof.

3. The cleaning system of claim 1 wherein said base in both baths (a) and (c) comprises sodium hydroxide, potassium hydroxide, ammonium hydroxide, or a mixture thereof.

4. The cleaning system of claim 2 wherein said base in both baths (a) and (c) comprises sodium hydroxide, potassium hydroxide, or a mixture thereof.

5. The cleaning system of claim 1 wherein said EDTA in both baths (a) and (c) is present as an aqueous solution of ammonium EDTA, sodium EDTA, or a combination thereof.

6. The cleaning system of claim 1 further comprising a third bath (b) located between the first and the second baths, wherein said third bath comprises water.

7. The cleaning system of claim 1 further comprising a forth bath (d) located after the second bath (c), wherein said third bath comprises water.

8. The cleaning system of claim 1 wherein said first bath comprises from 0.5 to 15 percent by weight of EDTA.

9. The cleaning system of claim 1 wherein said first bath comprises from 1 to 10 percent by weight of EDTA.

10. The cleaning system of claim 1 wherein each bath has a temperature of from 30° C. to 80° C.

11. A method for cleaning a mold or former for forming a latex article, wherein said method comprises:
a) immersing said mold or former into a cleaning bath comprising EDTA;
b) optionally immersing said mold or former into at least one water bath;
c) optionally immersing said mold or former into a second cleaning bath comprising an aqueous solution of from 0.5 to 15 weight percent of one or more cleaning agents selected from the group consisting of ETDA, detergent, and base; and
d) optionally immersing said mold or former into a final water bath.

12. The method of claim 11 wherein each cleaning and water bath has a temperature of from 30° C. to 80° C.

13. The method of claim 12 wherein each immersion into said cleaning and water baths has a duration of from 3 to 60 seconds.

14. The method of claim 13 wherein each immersion into said cleaning and water baths has a duration of from 5 to 20 seconds.
